(19) United States
(12) Patent Application Publication
(10) Pub. No.: US 2014/0055816 A1
(43) Pub. Date: Feb. 27, 2014

(54) SERVER, METHOD FOR TRANSMITTING DATA, AND IMAGE FORMING SYSTEM

(71) Applicants: Toshiba Tec Kabushiki Kaisha, Tokyo (JP); KABUSHIKI KAISHA TOSHIBA, Tokyo (JP)

(72) Inventor: Masato SEKINE, Tokyo (JP)

(73) Assignees: Toshiba Tec Kabushiki Kaisha, Tokyo (JP); KABUSHIKI KAISHA TOSHIBA, Tokyo (JP)

(21) Appl. No.: 13/971,715

(22) Filed: Aug. 20, 2013

(30) Foreign Application Priority Data
Aug. 21, 2012 (JP) 2012-181981

(51) Int. Cl. G06F 3/12

(52) U.S. Cl. CPC G06F 3/1212
USPC 358/1.15

(57) ABSTRACT

A server includes a storage unit configured to store first data and second data, an interface through which the first and second data stored in the storage unit are to be transmitted to an image forming device, and a control unit. The control unit is configured to start transmission of the first data from the storage unit to the image forming device through the interface, to interrupt the transmission of the first data in response to a request of transmission of the second data to the image forming device, and to start transmission of the second data from the storage unit to the image forming device through the interface after the transmission of the first data is interrupted.

### CROSS-REFERENCE TO RELATED APPLICATION

This application is based upon and claims the benefit of priority from Japanese Patent Application No. 2012-181981, filed Aug. 21, 2012, the entire contents of which are incorporated herein by reference.

### FIELD

Embodiment described herein relate generally to a print server connected to an image forming device and a client terminal through a network.

### BACKGROUND

In recent years, a network printing system in which a plurality of client terminals is connected to an image forming device and a print server has been used. In this system, a user registers print data with the print server in advance from a client terminal. In order to perform printing, the user operates the image forming device to issue a print instruction, and the image forming device receives the print data that is transmitted from the print server based on the print instruction.

With the technique described above, the print server transfers print data to the image forming device in the order in which the print instruction is issued by the image forming device. Thus, when a print instruction of print data which will take a long time to be received from the print server is issued, if another user subsequently commands the same image forming device to issue a print instruction for urgent print data, the user has to wait for the urgent print data to be transmitted until the reception of the former print data is completed.

### DESCRIPTION OF THE DRAWINGS

FIG. 1 is a diagram showing an example of a configuration of a network printing system according to a first embodiment.

FIG. 2 is a block diagram showing a configuration of a client terminal according to the first embodiment.

FIG. 3 is a block diagram showing a configuration of a print server according to the first embodiment.

FIG. 4 is a block diagram showing a configuration of an image forming device according to the first embodiment.

FIG. 5 is a block diagram showing a configuration of an authentication server according to the first embodiment.

FIG. 6 is a setup dialog box used for a user to set up a first threshold.

FIG. 7 is a flow chart showing steps for registering print data according to the first embodiment.

FIG. 8 is a setup dialog box by which a selection to permit or reject overtaking is made.

FIG. 9 is a flow chart showing steps for printing according to the first embodiment.

FIG. 10 is an example of a print list screen displayed on a liquid crystal display of the image forming device according to the first embodiment.

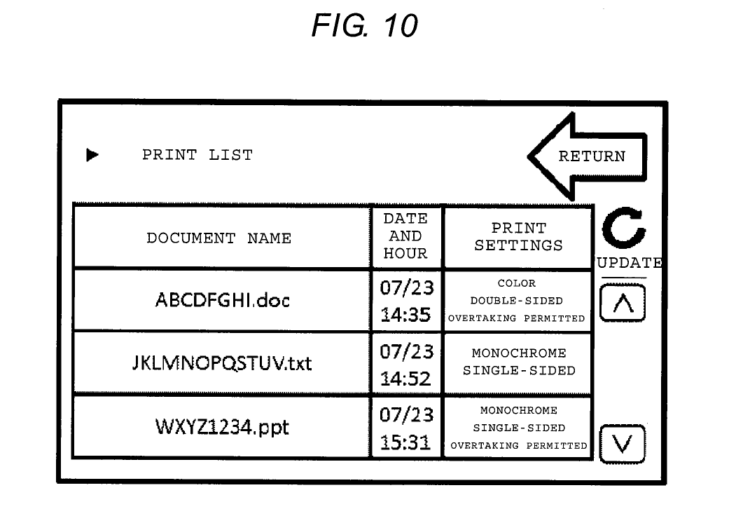

FIG. 11 is a flow chart showing steps for registering print data according to a second embodiment.

FIG. 12 is a flow chart showing steps for printing according to the second embodiment.

FIG. 13 is a flow chart showing steps for registering print data according to a third embodiment.

### DETAILED DESCRIPTION

In general, according to one embodiment, a server includes a storage unit configured to store first data and second data, an interface through which the first and second data stored in the storage unit are to be transmitted to an image forming device, and a control unit. The control unit is configured to start transmission of the first data from the storage unit to the image forming device through the interface, to interrupt the transmission of the first data in response to a request of transmission of the second data to the image forming device, and to start transmission of the second data from the storage unit to the image forming device through the interface after the transmission of the first data is interrupted.

Embodiments of the present disclosure will be described as follows.

According to an embodiment, a print server is capable of reducing a waiting time for urgent print data and improving usability of a transfer control.

### First Embodiment

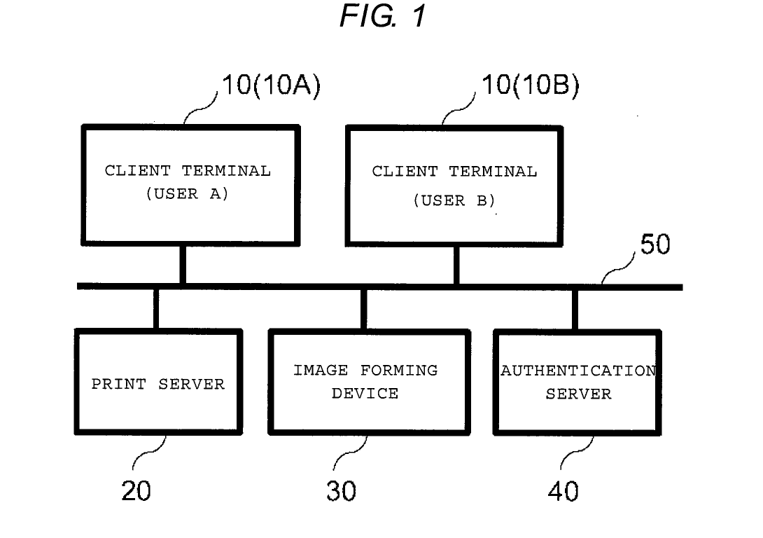

FIG. 1 is a diagram showing an example of a configuration of a network printing system.

The network printing system includes a plurality of client terminals (10A, 10B), a print server 20, an image forming device 30, and an authentication server 40. The client terminals 10, the print server 20, the image forming device 30, and the authentication server 40 are connected to one another through a network 50 such as the LAN (Local Area Network).

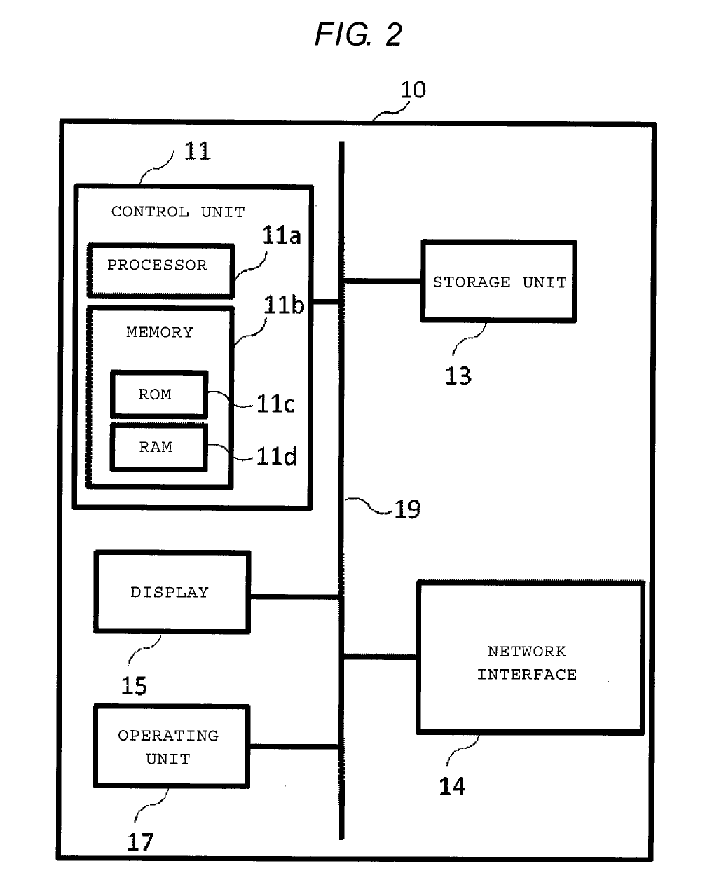

FIG. 2 is a block diagram showing a hardware configuration of the client terminal 10. The client terminal 10 is a device used by a user, and has a function of transmitting print data to the print server 20 through the network 50. The client terminal 10 may be a PC (Personal Computer), for example. The client terminal 10 includes a control unit 11, a storage unit 13, a network interface 14, a display 15, and an operating unit 17, and respective components are connected to one another through a bus 19.

The control unit 11 includes a processor 11a formed of a CPU (Central Processing Unit) or an MPU (Micro Processing Unit), and a memory 11b. The memory 11b may be a semiconductor memory, for example, and includes a ROM (Read Only Memory) 11c storing various control programs and a RAM (Random Access Memory) 11d providing a temporary working area to the processor 11a.

The control unit 11 executes application programs stored in the storage unit 13 to perform various processes. For example, the control unit 11 transmits print data which is printed out by the image forming device 30 to the print server 20 through the network interface 14.

The storage unit 13 stores an application program, a printer driver, and identification information. The application program includes a Web browser and a Web application in addition to general software. The printer driver is a device driver by which the print server 20 or the image forming device 30 is controlled according to a print instruction based on the application program. The identification information includes information identifying a user who requests print data from the print server 20 or the image forming device 30, or the client terminal 10 which sends the print data.

The storage unit 13 may be a hard disk drive or other magnetic storage devices, such as an optical storage device, and a semiconductor storage device such as a flash memory, or any combination thereof, for example.

The network interface 14 is an interface for connecting with an external device through the network 50. The network interface 14 includes appropriate wireless or wired interfaces conforming to IEEE 802.15, IEEE 802.11, IEEE 802.3, IEEE 1284, and the like, such as Bluetooth (registered trademark), an infrared connection and an optical connection.

The display 15 displays various types of data such as print data which is output by the image forming device 30. For example, the display 15 is a display provided in the client terminal 10.

The operating unit 17 may be a keyboard, a mouse, or the like, which can be used for a user to input a user instruction.

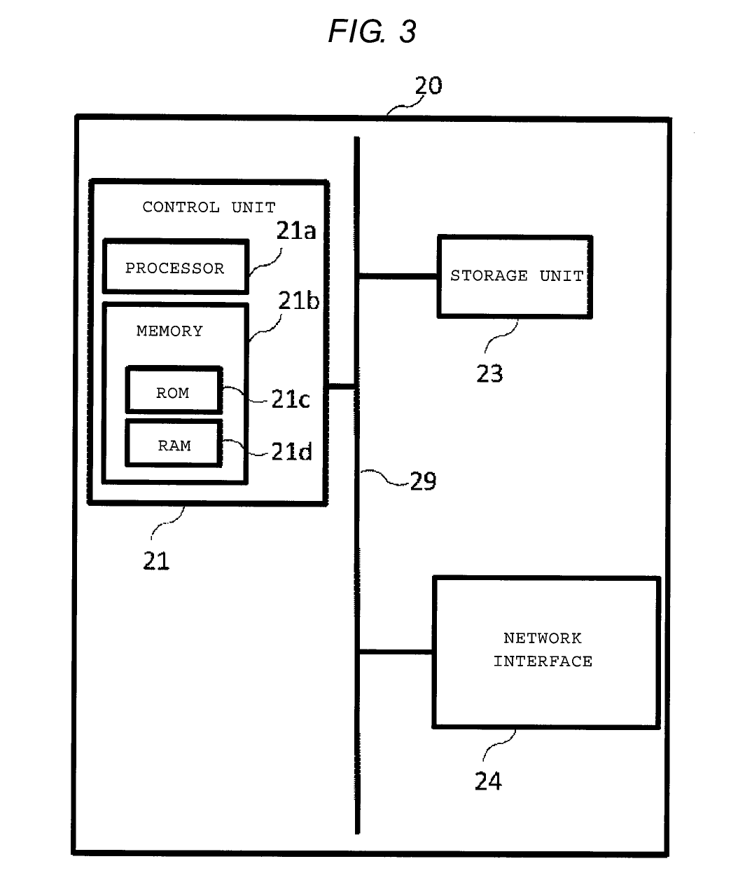

FIG. 3 is a block diagram showing a hardware configuration of the print server 20. The print server 20 stores print data received from the client terminal 10, and transfers the print data to the image forming device 30 according to the request from the user who manipulates the image forming device 30. The print server 20 includes a control unit 21, a storage unit 23, and a network interface 24, and respective components are connected to one another through a bus 29.

The control unit 21 mainly includes a processor 21a and a memory 21b and has a function of executing application programs stored in the storage unit to perform various processes. For example, the control unit 21 transfers print data stored in the storage unit 23 to the image forming device 30 according to the request from the image forming device 30. The storage unit 23 stores print data received from the client terminal 10, and identification information, a first threshold, and overtaking permission/rejection information, each of which is received along with the print data. The first threshold and the overtaking permission/rejection information will be described later. The network interface 24 is an interface for communicating with an external device connected to the network 50.

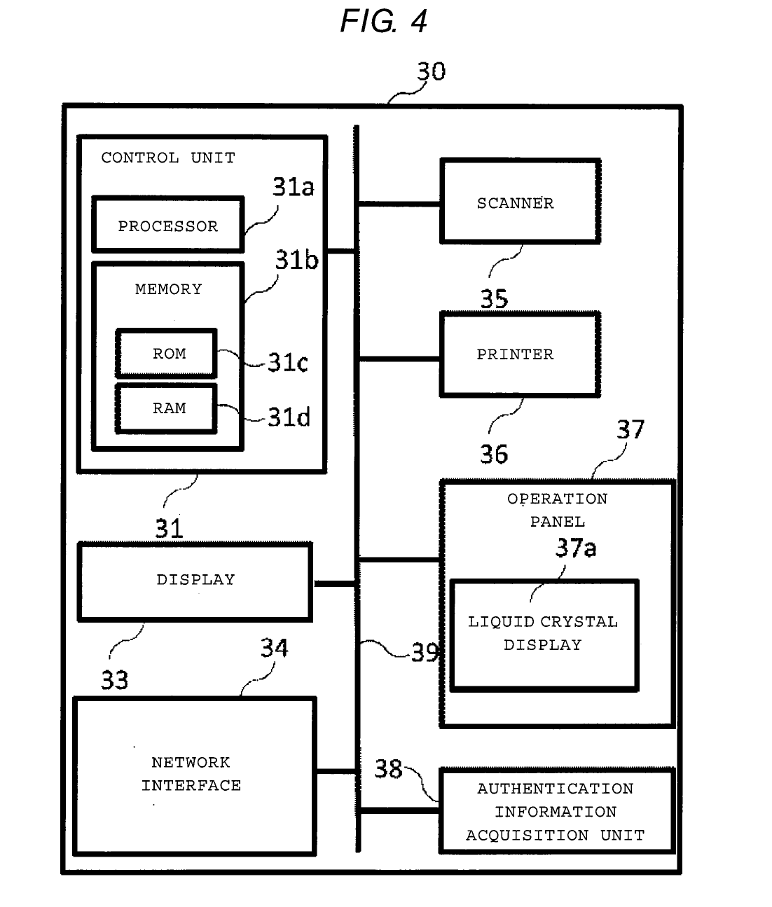

FIG. 4 is a block diagram showing a hardware configuration of the image forming device 30. The image forming device 30 has a function of presenting to the user the print data stored in the print server 20, receiving the print data selected by the user from the print server 20 and outputting it. For example, the image forming device 30 may be an MFP (Multi Function Peripheral). The image forming device 30 includes a control unit 31, a storage unit 33, a network interface 34, a scanner 35, a printer 36, an operation panel 37, and an authentication information acquisition unit 38, and respective components are connected to one another through a bus 39.

The control unit 31 mainly includes a processor 31a and a memory 31b and has a function of executing application programs stored in the storage unit 33 to perform various processes. For example, the control unit 31 controls the communication with the print server 20, causes a liquid crystal display 37a to display information acquired from the print server 20, and prints out print data acquired from the print server 20. The storage unit 33 temporarily stores the print data to be printed out. The network interface 34 is an interface for communicating with an external device connected to the network 50. The scanner 35 scans an image. The printer 36 prints out on paper an image based on the print data. The operation panel 37 is a panel provided with the liquid crystal display 37a which includes a touch panel therein. In this case, an operation guide, a touch key, or the like is displayed on the liquid crystal display 37a of the operation panel 37. The authentication information acquisition unit 38 acquires the authentication information of the user.

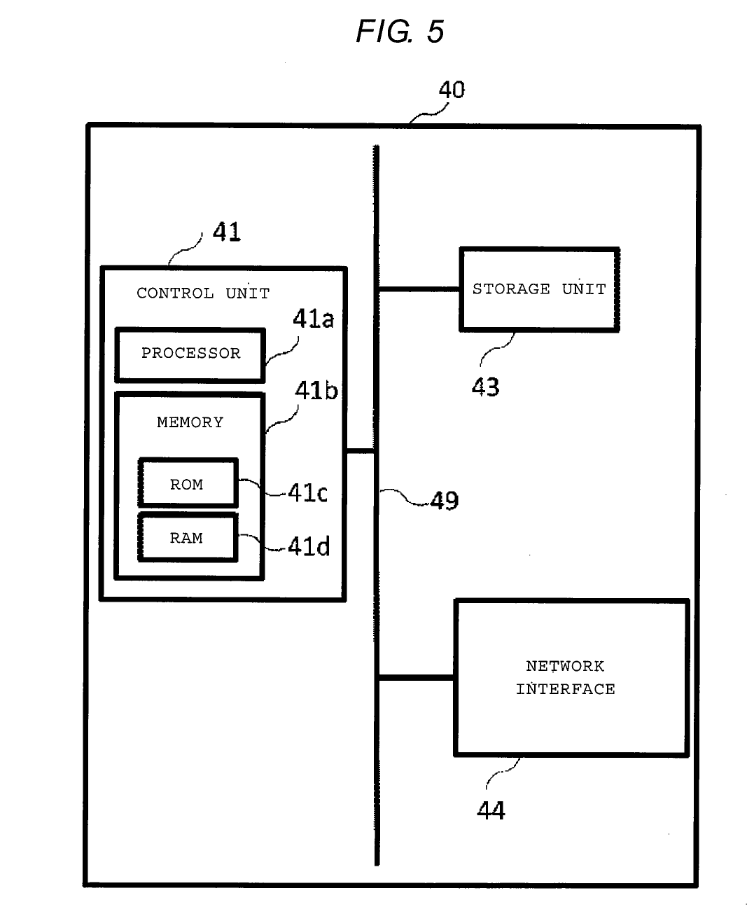

FIG. 5 is a block diagram showing a hardware configuration of the authentication server 40. The authentication server 40 is a server for performing user authentication based on authentication information provided from the image forming device 30. The authentication server 40 includes a control unit 41, a storage unit 43, and a network interface 44, and respective components are connected to one another through a bus 49.

The control unit 41 mainly includes a processor 41a and a memory 41b and has a function of executing application programs stored in the storage unit 43 to perform various processes. For example, the control unit 41 performs user authentication based on whether authentication information provided from the image forming device 30 matches registrant authentication information (registrant information) stored in the storage unit 43. The storage unit 43 stores registrant information. The network interface 44 is an interface for communicating with an external device connected to the network 50.

The print server 20 may also have the authentication function instead of the authentication server 40.

The operation of the network printing system according to the first embodiment will be described as follows.

First, when print data will take a long time to be transferred from the print server 20 to the image forming device 30, the system asks the user whether the user wishes to permit overtaking by another print data. On the other hand, for print data determined to take little time to be transferred, it is automatically determined that the overtaking by another print data is not permitted. The determination criterion time length is set up as a first threshold.

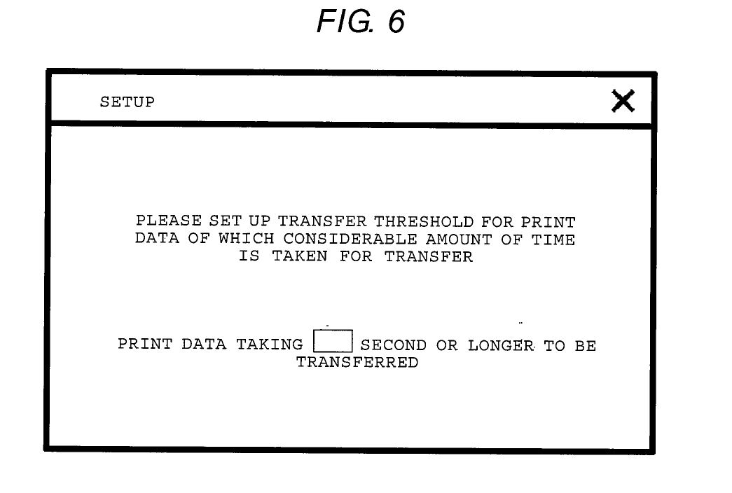

FIG. 6 is a setup dialog box used for a user to set up the first threshold. The setup dialog box is displayed on the display 15 of the client terminal 10 or the liquid crystal display 37a of the image forming device 30 when a printer driver is installed, or when a user or the administrator of the print server 20 performs a predetermined operation on the printer driver or the operation panel 37 of the image forming device 30. The user or the administrator operates the operating unit 17 or the liquid crystal display to input an arbitrary time length in order to set up a first threshold. The set first threshold is transmitted to the print server 20 through the network 50 and stored in the storage unit 23. Of course, the system may automatically set up the first threshold.

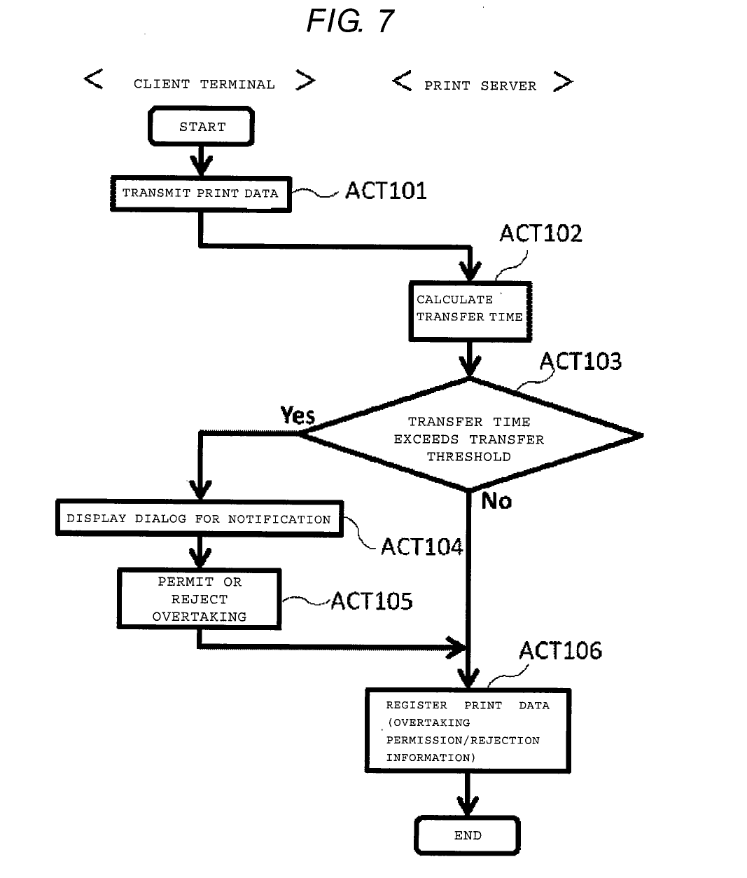

Next, the registration flow of print data according to the first embodiment will be described with reference to the flow chart of FIG. 7.

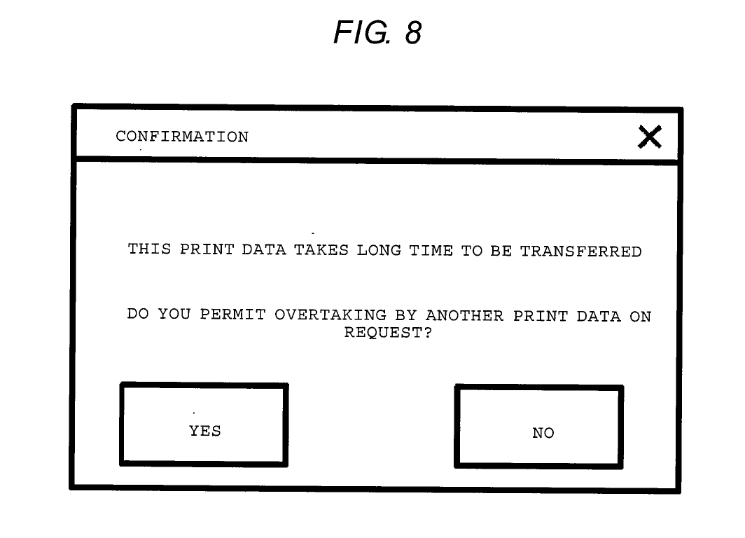

First, when user A commands the client terminal 10A to perform printing using the printer driver, the control unit 11 of the client terminal 10A transmits print data “a” and identification information to the print server 20 through the network 50 (ACT 101). The control unit 21 of the print server 20 that received the print data “a” and so on calculates the transfer time taken to transfer the print data a from the print server to the image forming device based on the amount of the received print data (ACT 102). Next, the control unit 21 compares the calculated transfer time with the first threshold stored in the storage unit 33 (ACT 103). That is to say, the control unit 21 determines whether the calculated transfer time exceeds the first threshold. When the calculated transfer time does not exceed the first threshold (ACT 103, No), the print data is associated with the identification information that is received along with the print data “a,” and stored in the storage unit 23 (ACT 106), and then the registration is completed. On the other hand, when the calculated transfer time exceeds the threshold (ACT 103, Yes), a predetermined signal is transmitted to the client terminal 10A through the network 50. The client terminal 10A that received the signal causes the control unit 11 to display on the display 15 a dialog box shown in FIG. 8 in order to notify the user that the print data will take a long time to be transferred (ACT 104). In response to the notification, the user A selects whether to permit or reject the overtaking (ACT 105). The overtaking permission/rejection information from the user A is transmitted to the print server 20. The control unit 21 of the print server 20 associates the received overtaking permission/rejection information with the identification information and the print data “a,” which are in turn stored in the storage unit 23 of the print server 20 (ACT 106), and then the registration is completed.

In order to display the dialog box on the display 15, the control unit 21 of the print server 20 may transmit the information as to the dialog box to the client terminal 10A.

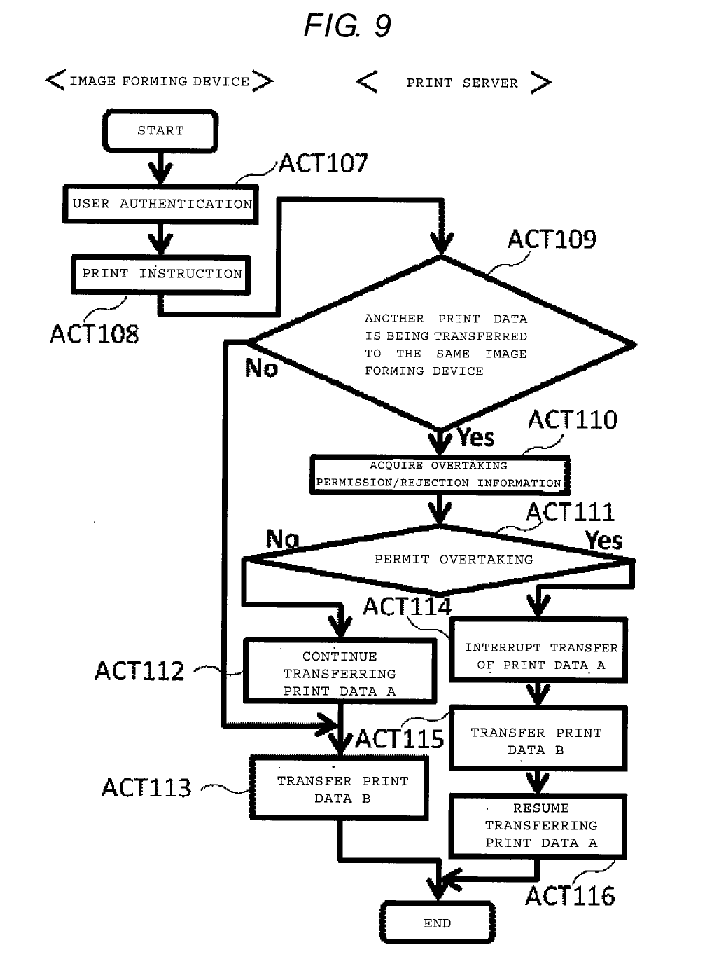

Next, the operation of the network printing system when user B commands the image forming device 30 to perform printing will be described with reference to the flow chart of FIG. 9. Here, print data “b” also has already been registered with the print server 20 by following the registration flow described above (ACT 101-ACT 106).

First, the user B inputs authentication information into the authentication information acquisition unit 38 of the image forming device 30. The control unit 31 of the image forming device 30 transmits the authentication information acquired through the authentication information acquisition unit 38 to the authentication server 40. The control unit 41 of the authentication server 40 that received the authentication information determines whether the received authentication information matches the registrant information stored in the storage unit 43 to authenticate the user (ACT 107). When the user authentication is completed, the control unit 31 of the image forming device 30 transmits the user information to the print server 20. The control unit 21 of the print server 20 causes the liquid crystal display 37a of the image forming device 30 to display the list of print data of the user B stored in the storage unit 23 based on the received user information and the identification information stored in the storage unit 23. Next, when the user B selects the print data “b” from the list of the print data displayed on the liquid crystal display 37a (ACT 108), the control unit 31 of the image forming device 30 transmits the selection information to the print server 20. The print server 20 that received the selection information causes the control unit 21 to determine whether another print data is being transferred by another user in the image forming device 30 (ACT 109). When no print data is being transferred (ACT 109, No), the control unit 21 transfers the print data “b” to the image forming device 30 based on the selection information (ACT 113). On the other hand, when the print data “a” of the user A is being transferred (ACT 109, Yes), the control unit 21 acquires overtaking permission/rejection information for the print data “a” from the storage unit 23 (ACT 110). When the acquired overtaking permission/rejection information indicates the rejection of overtaking (ACT 111, No), the control unit 21 continues transferring the print data “a” (ACT 112) and then transfers the print data “b” upon completion of the transfer of the print data “a” (ACT 113). On the other hand, when the acquired overtaking permission/rejection information indicates the permission of overtaking (ACT 111, Yes), the control unit 21 interrupts transfer of the print data “a” (ACT 114), and transmits a signal to the image forming device 30 through the network 50. The image forming device 30 that received the signal causes the control unit 31 to store a print data “a′” which is a part of the print data “a” that has already been transferred in the storage unit 33. Then, the control unit 21 of the print server 20 starts transferring the print data “b” (ACT 115). When the transfer of the print data “b” is completed, the control unit 31 of the image forming device 30 calls the print data “a′” stored in the storage unit 33, and the control unit 21 of the print server resumes transferring the print data “a” (ACT 116).

According to the first embodiment described above, the transfer waiting time for urgent print data can be reduced by setting the permission to overtake the data being transferred. In addition, by notifying the client terminal 10 that the calculated transfer time exceeds the first threshold, the user can recognize that the print data will take a long time to be transferred when the user registers the print data with the print server 20.

Further, according to the first embodiment, when the list of print data of the user stored in the storage unit 23 of print server 20 is displayed on the liquid crystal display 37a of the image forming device 30, the overtaking permission/rejection information is displayed for each print data as shown in FIG. 1, so that the user can recognize the overtaking permission/rejection information which has been set up by the user him/herself at the time of registration of the print data on the liquid crystal display 37a of the image forming device 30.

### Second Embodiment

The configuration of the network printing system and the setup method of the first threshold according to a second embodiment are similar to those of the first embodiment. The second embodiment is different from the first embodiment in that the overtaking permission/rejection is set up when a user requests the print server 20 to print out print data through the image forming device 30.

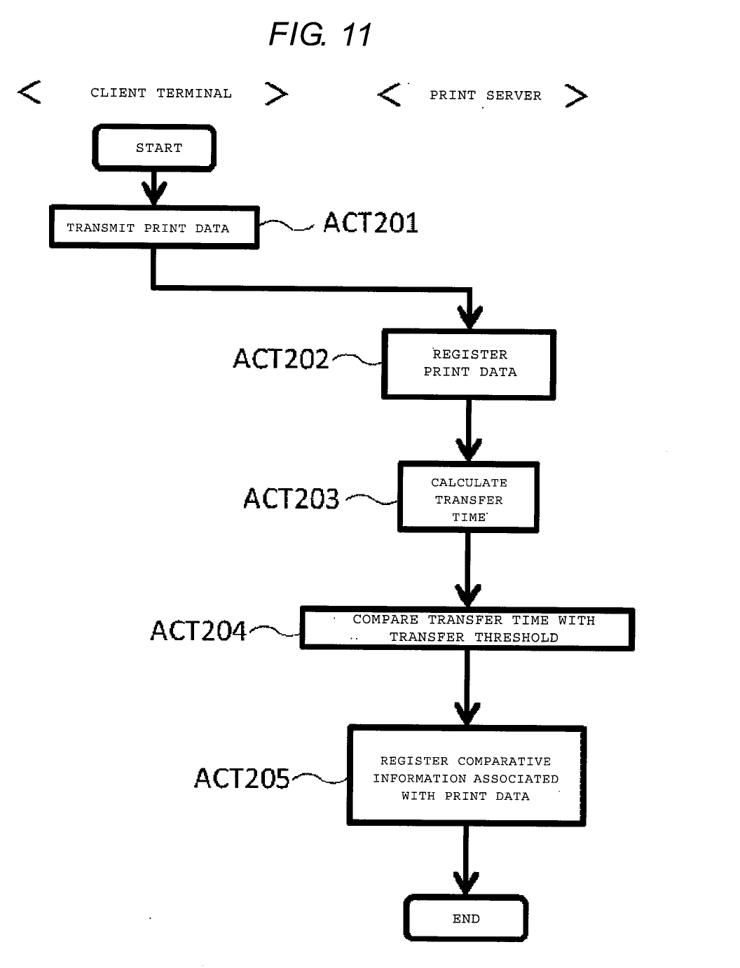

The registration flow of print data according to the second embodiment will be described with reference to the flow chart of FIG. 11.

First, when user A commands the client terminal 10A to perform printing using the printer driver, the control unit 11 of the client terminal 10A transmits print data “a” and identification information to the print server 20 through the network 50 (ACT 201). The control unit 21 of the print server 20 stores the received print data “a” and the identification information in the storage unit 23, and thus the registration is completed (ACT 202). Next, the control unit 21 calculates the transfer time of the print data “a” (ACT 203) and compares the calculated transfer time with the first threshold stored in the storage unit 33 (ACT 204). The control unit 21 associates the comparative information with the print data “a” and the identification information, which are in turn stored in the storage unit 23 (ACT 205).

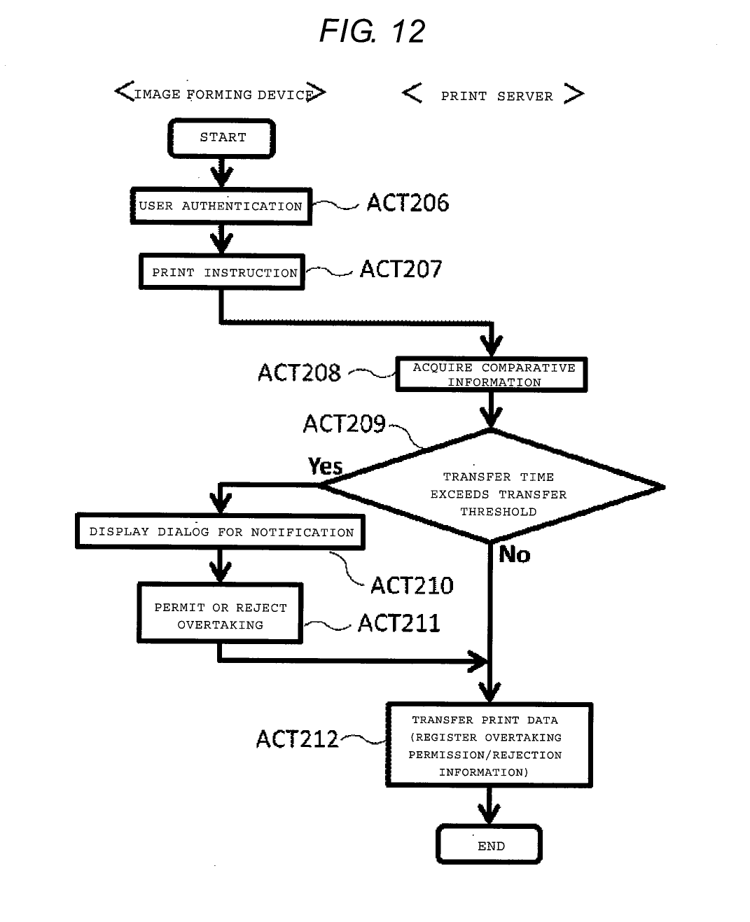

Next, the operation of the network printing system when user A commands the image forming device 30 to perform printing will be described with reference to the flowchart of FIG. 12.

First, the user A uses the authentication information acquisition unit 38 of the image forming device 30 to perform user authentication as in the user B in the first embodiment (ACT 206). When the user selects the print data “a” from the list of print data (ACT 207) after the user authentication is completed, the control unit 31 transmits the selection information to the print server 20. The print server 20 that received the selection information causes the control unit 21 to call the print data “a” and the comparative information from the storage unit 23 (ACT 208). When the calculated transfer time is less than the threshold based on the comparative information (ACT 209, No), the control unit 21 starts transferring the print data “a” (ACT 212). On the other hand, when the calculated transfer time exceeds the threshold (ACT 209, Yes), this is notified to the liquid crystal display 37a of the image forming device 30 as in the first embodiment (ACT 210), and the user selects whether to permit or reject the overtaking (ACT 211). The control unit 31 of the image forming device transmits the selected information to the print server 20. The print server 20 that received the overtaking permission/rejection information causes the control unit 21 to register the overtaking permission/rejection information with the storage unit 23, and starts transferring the print data “a” (ACT 212).

The subsequent processes performed by the user B are similar to those of the first embodiment (ACT 107-ACT 116).

According to the second embodiment, since the transfer time is calculated after the user registers the print data with the print server 20, there is no additional waiting time due to calculation and the like when print data is registered with the print server 20 and a print instruction is issued from the image forming device 30.

In addition, when the user selects a plurality of print data through the image forming device 30, the control unit 21 compares the total time of the transfer of the selected print data with the first threshold, and thus the same effect as that of the aforementioned embodiment can be achieved.

The print server 20 according to an embodiment may combine processes of the first and second embodiments to notify that the transfer time exceeds the first threshold. For example, in accepting the registration of print data from a user, the control unit 21 of the print server 20 may determine whether the transfer time of the print data exceeds the first threshold, and, when the transfer time of the single print data exceeds the first threshold, notify the client terminal 10 that the transfer time exceeds the first threshold. Alternatively, in accepting the registration of print data, when the transfer time of the print data does not exceed the first threshold, and when the total time of the transfer of a plurality of print data selected through the image forming device 30 by the user operation exceeds the first threshold, the control unit 21 of the print server 20 may notify the image forming device 30 that the transfer time exceeds the first threshold.

### Third Embodiment

In a third embodiment, the storage unit 13 of each client terminal 10 maintains the first threshold, and the control unit 11 of each client terminal 10 calculates transfer time and compares the transfer time with the first threshold, and then the control unit 11 transmits print data and overtaking permission/rejection information to the print server 20, and then the registration with the print server is completed.

The configuration of the network printing system of the third embodiment is similar to that of the first embodiment. As individual components, the third embodiment is different from the first embodiment in that the first threshold is stored in the storage unit 13 of the client terminal 10.

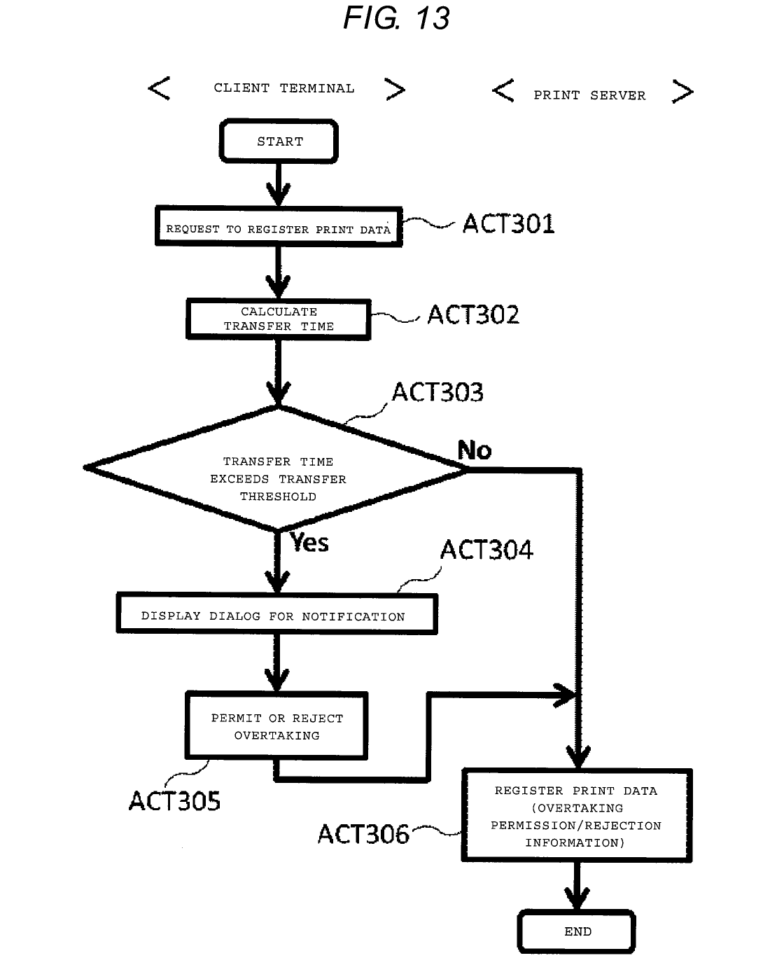

The registration flow of print data according to the third embodiment will be described with reference to the flow chart of FIG. 13.

First, when user A commands the client terminal 10A to print out print data “a” through the printer driver (ACT 301), the control unit 11 of the client terminal 10A calculates transfer time needed to transfer the print data “a” from the print server to the image forming device based on the amount of the received print data (ACT 302). Next, the control unit 11 compares the calculated transfer time with the first threshold stored in the storage unit 13 (ACT 303). When the transfer time does not exceed the first threshold (ACT 303, No), the control unit 11 transmits the print data “a” and identification information to the print server 20. The print server 20 that received them causes the control unit 21 to associate the print data “a” with the identification information, which are in turn stored in the storage unit 23 (ACT 306), and then the registration is completed. On the other hand, when the calculated transfer time exceeds the threshold (ACT 303, Yes), the control unit 11 of the client terminal 10A notifies the display 15 thereof (ACT 304), and causes the user A to select to permit or reject the overtaking (ACT 305). The control unit 11 transmits the overtaking permission/rejection information, the print data “a” and the identification information to the print server 20, and the control unit 21 of the print server 20 stores these three data in the storage unit 23 (ACT 306), and then the registration is completed.

The subsequent flow of printing performed by the user B is similar to those of the first and second embodiments (ACT 107-ACT 116).

According to the third embodiment, the same effect as that of the first embodiment can be achieved. Further, the load on the print server 20 can be reduced when a plurality of print data are requested to be registered with the print server 20 at the same time. In addition, as a variation of the third embodiment, when print data is registered with the print server 20, comparative information, print data, and identification information may be registered by the control unit 11 of the client terminal 10, and a user may select whether to permit or reject the overtaking when selecting print data through the image forming device 30 as in the first embodiment.

According to at least one of the embodiments described above, the permission of overtaking is set up on print data taken a long time to be transferred from a print server to an image forming device, so that the image forming device transfers and prints out urgent print data preferentially, thus reducing a user waiting time and improving the usability.

The present disclosure is not limited to the embodiments described above, and various variations are possible. In the embodiments 1 to 3, a plurality of print data performing overtaking are from different client terminals (users), but the application is possible to a plurality of print data from the same client terminal (user).

Further, in the embodiments described above, when multiple overtakings occur, it is conceivable that considerable amount of time is taken for the transfer of print data “a” to resume. Even though the user A permits the overtakings, this is not very practical. Thus, a second threshold which is the maximum of a time length during which the user permits overtaking may be set up, so that the overtaking is not permitted for the print data for which the total time of transfer interruption due to overtaking exceeds the second threshold, and the transfer of the print data “a” is resumed. In this manner, this can ensure a defined print finish time to a user who permits overtaking. Of course, the system may automatically set up the second threshold.

Further, the transfer time according to the embodiments may be taken as the time including the time taken for the RIP process (Raster Image Processor) for generating a raster image which can also be measured based on the amount of print data.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server comprising:
a storage unit configured to store first data and second data;
an interface through which the first and second data stored in the storage unit are to be transmitted to an image forming device; and
a control unit configured to:
start transmission of the first data from the storage unit to the image forming device through the interface;
interrupt the transmission of the first data in response to a request of transmission of the second data to the image forming device; and
start transmission of the second data from the storage unit to the image forming device through the interface after the transmission of the first data is interrupted.

2. The server according to claim 1, wherein
the control unit is configured to interrupt the transmission of the first data if a time period to transmit the first data from the storage unit to the image forming device is greater than a predetermined time period, and
the control unit is configured to keep the transmission of the first data if the time period to transmit the first data is not greater than the predetermined time period.

3. The server according to claim 2, wherein
the control unit is configured to calculate the time period to transmit the first data.

4. The server according to claim 3, wherein
the storage unit is configured to store the predetermined time period and the calculated time period.

5. The server according to claim 1, wherein
the control unit is configured to resume the transmission of the first data after the transmission of the second data is completed.

6. The server according to claim 1, wherein
the control unit is configured to:
interrupt the transmission of the second data when a predetermined time period has passed after the transmission of the first data is interrupted; and
resume the transmission of the first data after the transmission of the second data is interrupted.

7. The server according to claim 1, wherein
the control unit is configured to interrupt the transmission of the first data if the control unit receives information indicating that the transmission of the first data may be interrupted, and
the control unit is configured to keep the transmission of the first data if the control unit does not receive the information.

8. The server according to claim 7, wherein
the image forming device includes a display unit, and
the control unit is configured to cause the display unit to display identification information of the first data together with information indicating whether or not the transmission of the first data may be interrupted.

9. A method for transmitting data from a server to an image forming device, the method comprising:
starting transmission of the first data from the server to the image forming device;
interrupting the transmission of the first data in response to a request of transmission of the second data to the image forming device; and
starting transmission of the second data from the server to the image forming device after the transmission of the first data is interrupted.

10. The method according to claim 9, wherein
the transmission of the first data is interrupted if a time period to transmit the first data from the storage unit to the image forming device is greater than a predetermined time period, and
the transmission of the first data is kept if the time period to transmit the first data is not greater than the predetermined time period.

11. The method according to claim 10, further comprising:
calculating the time period to transmit the first data.

12. The method according to claim 11, further comprising:
storing the predetermined time period; and
storing the calculated time period.

13. The method according to claim 10, further comprising:
resuming the transmission of the first data after the transmission of the second data is completed.

14. The method according to claim 10, further comprising:
interrupting the transmission of the second data when a predetermined time period has passed after the transmission of the first data is interrupted; and
resume the transmission of the first data after the transmission of the second data is interrupted.

15. The method according to claim 10, wherein
the transmission of the first data is interrupted if information indicating that the transmission of the first data may be interrupted is received by the server, and
the transmission of the first data is kept if the information is not received by the server.

16. The method according to claim 15, further comprising:
displaying identification information of the first data together with information indicating whether or not the transmission of the first data may be interrupted.

17. An image forming system comprising:
an image forming device configured to form an image on a medium;
a server comprising:
a storage unit configured to store first data and second data;
an interface through which the first and second data stored in the storage unit are to be transmitted to an image forming device; and
a control unit configured to:
start transmission of the first data from the storage unit to the image forming device through the interface;
interrupt the transmission of the first data in response to a request of transmission of the second data to the image forming device; and
start transmission of the second data from the storage unit to the image forming device through the interface after the transmission of the first data is interrupted; and
a processing device configured to transmit the first data to the server to be stored in the storage unit.

18. The image forming system according to claim 17, wherein
the control unit is configured to interrupt the transmission of the first data if a time period to transmit the first data from the storage unit to the image forming device is greater than a predetermined time period, and
the control unit is configured to keep the transmission of the first data if the time period to transmit the first data is not greater than the predetermined time period.

19. The image forming system according to claim 17, wherein
the control unit is configured to interrupt the transmission of the first data if the control unit receives information indicating that the transmission of the first data may be interrupted, and
the control unit is configured to keep the transmission of the first data if the control unit does not receive the information.

20. The image forming system according to claim 19, wherein
the image forming device includes a display unit, and
the control unit is configured to cause the display unit to display identification information of the first data together with information indicating whether or not the transmission of the first data may be interrupted.
